(19) United States
(12) Patent Application Publication
(10) Pub. No.: US 2023/0004074 A1
(43) Pub. Date: Jan. 5, 2023

(54) PARALLEL LINK APPARATUS

(71) Applicant: SONY GROUP CORPORATION, TOKYO (JP)

(72) Inventor: KAZUO HONGO, TOKYO (JP)

(21) Appl. No.: 17/756,779

(22) PCT Filed: Dec. 5, 2020
(86) PCT No.: PCT/JP2020/045355

§ 371 Date: Jun. 2, 2022

(30) Foreign Application Priority Data
Dec. 13, 2019 (JP) 2019-225421

(51) Int. Cl. G03B 17/56; F16M 11/38; F16M 11/20

(52) U.S. Cl. CPC G03B 17/561; F16M 11/38; F16M 11/2085; F16M 2200/061

(57) ABSTRACT

A parallel link apparatus includes: a base section; three or more deployment sections that extend radially from the base section and that are pivotable with end parts coupled to the base section being pivot axes; arm sections that are coupled to end parts, of the respective deployment sections, that are on opposite sides of the end parts coupled to the base section, and are pivotable with respect to the deployment sections and expandable and contractible in one direction independently of each other; and a movable section coupled to each of second ends, of the arm sections, that are on opposite sides of first ends, of the arm sections, coupled to the deployment sections.

### TECHNICAL FIELD

The present disclosure relates to a parallel link apparatus.

### BACKGROUND ART

In recent years, a parallel link structure attracts attention. For example, the parallel link structure attracts attention as a structure that allows for a high-speed operation of an arm section at a low power consumption because it is possible to configure a distal end side of an arm section constituting a parallel link to be light-weight and high rigidity.

As the parallel link structure, a delta structure that allows for a translational movement in three degrees of freedom, a Stewart platform having six degrees of freedom, and the like have been proposed. In addition, a parallel link structure that achieves a wider movable range in all of the three translational axes and the three rotational axes has been studied (for example, Patent Literature 1). The parallel link apparatus including the parallel link structure is utilized in various applications because of many features such as high-speed operation capability, high rigidity, easy designing of a wiring line and the like, and low power consumption.

### CITATION LIST

### Patent Literature

Patent Literature 1: Japanese Unexamined Patent Application Publication No. 2000-284228

### SUMMARY OF THE INVENTION

Accordingly, in order to further increase availability of a parallel link apparatus, an improvement in easiness of transportation of a parallel link apparatus is desired.

Accordingly, it is desirable to provide a parallel link apparatus with an improved storage property.

A parallel link apparatus according to one embodiment of the present disclosure includes: a base section; three or more deployment sections that extend radially from the base section and that are pivotable with end parts coupled to the base section being pivot axes; arm sections that are coupled to end parts, of the respective deployment sections, that are on opposite sides of the end parts coupled to the base section, and are pivotable with respect to the deployment sections and expandable and contractible in one direction independently of each other; and a movable section coupled to each of second ends, of the arm sections, that are on opposite sides of first ends, of the arm sections, coupled to the deployment sections.

According to the parallel link apparatus of one embodiment of the present disclosure, it is possible to support the base section by the three or more deployment sections that extend radially from the base section and that are pivotable with the end parts coupled to the base section being the pivot axes and by the arm sections that are coupled to the respective end parts of the deployment sections and are pivotable with respect to the deployment sections and expandable and contractible in one direction independently of each other. Thus, it is possible for the parallel link apparatus according to the embodiment of the present disclosure to deform, for example, in a storage state in which a space filling rate is high.

### BRIEF DESCRIPTION OF THE DRAWINGS

FIG. 1 is a perspective diagram illustrating a configuration example of a parallel link apparatus according to a first embodiment of the present disclosure.

FIG. 2A is a perspective diagram illustrating an example of a storage state of the parallel link apparatus according to the embodiment.

FIG. 2B is a top diagram illustrating an example of the storage state of the parallel link apparatus according to the embodiment.

FIG. 2C is a side diagram illustrating an example of the storage state of the parallel link apparatus according to the embodiment.

FIG. 3A is a perspective diagram illustrating an example of a deployment state of the parallel link apparatus according to the embodiment.

FIG. 3B is a top diagram illustrating an example of the deployment state of the parallel link apparatus according to the embodiment.

FIG. 3C is a side diagram illustrating an example of the deployment state of the parallel link apparatus according to the embodiment.

FIG. 4A is a perspective diagram illustrating an example of an attitude change of a movable section in the parallel link apparatus according to the embodiment.

FIG. 4B is a perspective diagram illustrating an example of the attitude change of the movable section in the parallel link apparatus according to the embodiment.

FIG. 4C is a perspective diagram illustrating an example of the attitude change of the movable section in the parallel link apparatus according to the embodiment.

FIG. 5 is a perspective diagram illustrating a configuration example of a parallel link apparatus according to a second embodiment of the present disclosure.

FIG. 6 is a schematic diagram illustrating a configuration of the parallel link apparatus according to the embodiment in a simplified fashion.

FIG. 7A is a perspective diagram illustrating an example of a storage state of the parallel link apparatus according to the embodiment.

FIG. 7B is a top diagram illustrating an example of the storage state of the parallel link apparatus according to the embodiment.

FIG. 7C is a side diagram illustrating an example of the storage state of the parallel link apparatus according to the embodiment.

FIG. 8A is a perspective diagram illustrating an example of a deployment state of the parallel link apparatus according to the embodiment.

FIG. 8B is a top diagram illustrating an example of the deployment state of the parallel link apparatus according to the embodiment.

FIG. 8C is a side diagram illustrating an example of the deployment state of the parallel link apparatus according to the embodiment.

FIG. 9A is a perspective diagram illustrating an example of an attitude change of a movable section in the parallel link apparatus according to the embodiment.

FIG. 9B is a perspective diagram illustrating an example of the attitude change of the movable section in the parallel link apparatus according to the embodiment.

FIG. 10 is a perspective diagram illustrating a configuration example of a parallel link apparatus according to a modification example of the embodiment.

FIG. 11 is a schematic diagram illustrating a configuration of the parallel link apparatus according to a modification example of the embodiment in a simplified fashion.

### MODES FOR CARRYING OUT THE INVENTION

Hereinafter, embodiments of the present disclosure will be described in detail with reference to the drawings. The embodiment described below is a specific example of the present disclosure, and a technique of the present disclosure is not limited to the following embodiment. In addition, the arrangement, dimensions, dimensional ratios, and the like of the respective components of the present disclosure are not limited to the embodiments illustrated in the respective drawings.

It should be noted that the description will be made in the following order.

### 1. First Embodiment

1.1. Configuration Example

1.2. Storage Example and Deployment Example

1.3. Operation Example

1.4. Workings and Effects

### 2. Second Embodiment

2.1. Configuration Example

2.2. Storage Example and Deployment Example

2.3. Operation Example

2.4. Modification Examples

2.5. Workings and Effects

### 3. Appendix

### 1. First Embodiment

### 1.1. Configuration Example

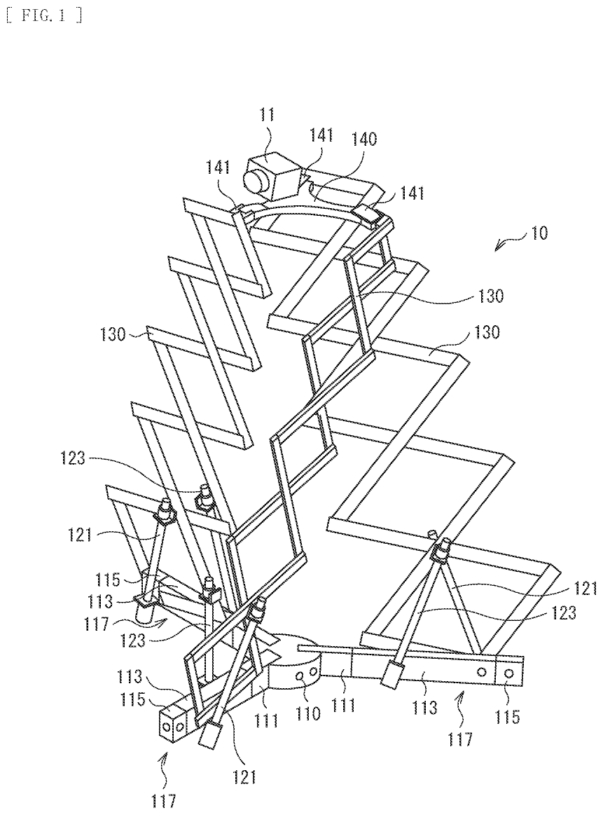

First, a configuration example of a parallel link apparatus according to a first embodiment of the present disclosure will be described with reference to FIG. 1. FIG. 1 is a perspective diagram illustrating a configuration example of a parallel link apparatus 10 according to the present embodiment.

As illustrated in FIG. 1, the parallel link apparatus 10 includes, for example, a base section 110, a deployment section 117, an arm section 130, a first actuator 121, a second actuator 123, a tip coupling section 141, and a movable section 140.

Each configuration may be formed using various hard-to-deform rigid materials, such as aluminum, stainless steel, or resin, unless otherwise noted. The rigid materials forming the respective configurations may be selected with an emphasis on rigidity, may be selected with an emphasis on lightness, or may be selected with an emphasis on manufacturing costs.

The base section 110 and the movable section 140 are coupled by at least three or more deployment sections 117 and arm sections 130 provided in parallel. The parallel link apparatus 10 is a link device in which a position and an attitude of the movable section 140 are controllable in three translational axes and three rotational axes by the first actuators 121 and the second actuators 123 that operate the deployment sections 117 and the arm sections 130.

The parallel link apparatus 10 may be used as a pedestal for photographing by installing an imaging device 11 on the movable section 140. It is possible for the parallel link apparatus 10 according to the present embodiment to allow the imaging device 11 to be movable freely in three translational axes and three rotational axes.

Although FIG. 1 illustrates the parallel link apparatus 10 in which three deployment sections 117, three arm sections 130, three first actuators 121, and three second actuators 123 are provided in parallel, a technique according to the present disclosure is not limited to such an example. For example, the parallel link apparatus 10 may include four or more deployment sections 117, four or more arm sections 130, four or more first actuators 121, and four or more second actuators 123 in parallel.

It should be noted that, in the present specification, out of the base section 110 and the movable section 140, the base section 110 side is also referred to as a base end side, and the movable section 140 side is also referred to as a tip side.

The base section 110 is a member serving as a base point to be installed on a ground or the like when the parallel link apparatus 10 is used. A shape of the base section 110 is not particularly limited, and may be, for example, a flat plate shape.

The deployment sections 117 extend radially at equal intervals from the base section 110, and are pivotably provided with end parts coupled to the base section 110 serving as pivot axes. Specifically, the deployment section 117 includes a base end coupling section 111 coupled to the base section 110, a pivot section 113 pivotable in a pivot axis in which an extending direction of the deployment section 117 is an axial direction, and a ground section 115 provided with a leg part or the like grounded to a ground or the like.

The base end coupling sections 111 are provided at even intervals (at 120 degrees each in FIG. 1) so as to be point symmetric with respect to the center of the base section 110. In addition, the base end coupling section 111 is provided pivotably with respect to a pivot axis in which an axis that passes through a coupling point between the base end coupling section 111 and the base section 110 and that is orthogonal to the extending direction of the deployment section 117 within a plane of a principal surface of the base section 110 serves as a pivot axis. In other words, the base end coupling section 111 is pivotably provided so as to be folded in a direction perpendicular to the principal surface of the base section 110 with a coupling part between the base end coupling section 111 and the base section 110 being the pivot axis.

The pivot section 113 further extends from the base end coupling section 111, and is pivotably provided with respect to a pivot axis in which an extending direction of the pivot section 113 serves as an axial direction. Specifically, the pivot section 113 is pivotably provided in which an axis that passes through the center of the pivot section 113 and extends in the extending direction of the pivot section 113 serves as the pivot axis.

The ground section 115 is provided at an end part on a tip side (i.e., on an opposite side of a side on which the base end coupling section 111 is coupled) of the pivot section 113. The ground section 115 is provided with an orientation thereof being fixed to the base end coupling section 111. That is, the pivot section 113 described above is provided so as to be pivotable with respect to the base end coupling section 111 and the ground section 115, and the ground section 115 is provided so as not to pivot in conjunction with the pivot section 113.

The ground section 115 may be provided with, for example, a leg part (not illustrated) that comes into contact with the ground or the like when the parallel link apparatus 10 is installed. The unillustrated leg part may be provided so as to be adjustable in height by a screw or the like, for example, in order to change an installation height of the parallel link apparatus 10. By providing a leg part, it is possible to install the parallel link apparatus 10 more stably. In addition, it is possible for the parallel link apparatus 10 to prevent a portion of the arm section 130 from coming into contact with the installed ground or the like.

The arm section 130 is pivotably provided in two degrees of freedom with respect to the base section 110 at the end part on the tip side of the deployment section 117. Specifically, the arm section 130 is pivotably coupled with a coupling point of the end part on the tip side of the pivot section 113 of the deployment section 117 serving as a pivot axis. Thus, it is possible for the arm section 130 to pivot, relative to the base section 110, in two degrees of freedom including a pivot axis in which the extending direction of the deployment section 117 serves as an axial direction and a pivot axis in which a direction orthogonal to the extending direction of the deployment section 117 within the plane of the principal surface of the base section 110 serves as an axial direction.

The arm section 130 is provided so as to be extendable and contractible in one direction toward an upper part of the base section 110 by a pantograph structure. The pantograph structure is a structure in which a plurality of contractible rhombic structures is linked, and is extendable and contractible in one direction by the contraction of the rhombic structures. The pantograph structure may be formed, for example, by pivotably coupling end parts of a cross-shaped link in which a middle part is pivotably coupled to end parts of a cross-shaped link having a similar configuration.

The pantograph structure is determined in an expansion contraction rate and an expansion contraction length by the number of couplings of the rhombic structures and a length of each of the links forming the rhombic structures. The expansion contraction rate and the expansion contraction length of the pantograph structure of the arm section 130 may be appropriately designed depending on an application of the parallel link apparatus 10. However, the pantograph structure of the arm section 130 may be configured such that the rhombic structure on the tip side is smaller than the rhombic structure on the base end side in order to prevent an interference or a contact of the mutual arm sections 130 in the vicinity of the movable section 140.

The first actuator 121 generates a power that causes the arm section 130 to expand and contract in one direction. Specifically, the first actuator 121 may include a ball screw provided on the diagonal of the rhombic structure on the most base end side of the pantograph structure of the arm section 130, and a motor that rotates the ball screw. Because it is possible for the first actuator 121 to contract each of the rhombic structures constituting the pantograph structure of the arm section 130 in conjunction with each other by the ball screw, it is possible to expand and contract the arm section 130 in one direction.

The second actuator 123 generates a power that causes the arm section 130 to pivot at a pivot axis that passes through a coupling point between the arm section 130 and the pivot section 113. Specifically, the second actuator 123 may include a ball screw provided between the pivot section 113 of the deployment section 117 and the arm section 130 and a motor that rotates the ball screw. Because it is possible for the second actuator 123 to cause a distance between the pivot section 113 and the arm section 130 to contract, it is possible to cause the arm section 130 to pivot at a pivot axis that passes through the coupling point between the arm section 130 and the pivot section 113.

The ball screw is configured by a threaded shaft, a nut, a ball, or the like, and is a mechanical element that converts a rotational motion of the motor into a linear motion. Because the ball screw has a low back drivability, it is possible to suppress the arm section 130 from rapidly contracting or falling down even in a case where the power from the motor is lost. In addition, it is possible for the ball screw to lower the back drivability by making a lead of the threaded shaft smaller.

The first actuator 121 and the second actuator 123 may be provided at the rhombic structure on the most base end side of the pantograph structure constituting the arm section 130. By providing the first actuator 121 and the second actuator 123 on the base end side of the arm section 130, it is possible for the parallel link apparatus 10 to have a lower center of gravity, thereby making it possible to improve an attitude stability. In addition, because it is possible to suppress an increase in the mass on the tip side of the arm section 130, it is possible for the parallel link apparatus 10 to increase an operation speed of the movable section 140 and to further reduce a power consumption at the time of operation.

A position of attachment of the second actuator 123 to the arm section 130 may substantially coincide with a position of attachment on the tip side of the arm section 130 of the first actuator 121. With this configuration, it is possible for the parallel link apparatus 10 to further simplify a control of the arm section 130 by the first actuator 121 and the second actuator 123.

The tip coupling sections 141 are provided at the movable section 140 at equal intervals so as to be point symmetric with respect to the center of the movable section 140. The tip coupling sections 141 pivotably couple the end parts on the tip end side of the respective arm sections 130 and the movable section 140 in three degrees of freedom. For example, the tip coupling section 141 may be a free joint that is freely rotatable at a coupling point.

In addition, the tip coupling sections 141 may couple the arm sections 130 and the movable section 140 such that each of the arm sections 130 is in a torsional relationship upon extension. With this configuration, it is possible for the parallel link apparatus 10 to further enlarge a movable range of the movable section 140 by the expansion and the contraction and the pivot of the arm sections 130.

The movable section 140 is a member that is made movable in the parallel link apparatus 10 by the expansion and the contraction and the pivot of each of the arm sections 130. Specifically, the movable section 140 is coupled to each of the arm sections 130 at the tip coupling sections 141 and is made movable in three translational axes and three rotational axes by the expansion and the contraction and the pivot of each of the arm sections 130. For example, the imaging device 11 may be mounted on the movable section 140. Thus, it is possible for the parallel link apparatus 10 to make the imaging device 11 freely movable in three translational axes and three rotational axes to allow the imaging device 11 to perform imaging of any space.

In recent years, imaging has been performed not only indoors but also outdoors, particularly in special environments such as high mountains. In such environments, by using robots or the like, it is possible to perform the imaging that is difficult for humans in a high-speed operation and at high reproducibility. For example, it has been attempted to obtain a captured image with high reproducibility by mounting the imaging device on a robot or a drone or the like whose operation is programmable.

However, because the drone is susceptible to wind, it is difficult to perform the imaging with high reproducibility. In addition, an industrial robot, such as a vertical-articulated robot, is not easy to transport and it is only possible to perform the imaging in certain installed environments. Further, a parallel wire device that operates the imaging device by wires stretched in parallel demands the large installation area, and is high in burden in terms of transportation and installation.

Accordingly, what is desired is a robotic device that allows for carrying and installation to an external environment or the like by a person and makes it possible to perform the imaging with a high reproducibility in a high-speed operation.

The parallel link apparatus 10 according to the present embodiment includes at least three or more deployment sections 117 that are foldable in a direction perpendicular to the principal surface of the base section 110, the arm sections 130 pivotably coupled to the deployment sections 117 and extendable and contractible in one direction, and the movable section 140 supported by each of the arm sections 130. The parallel link apparatus 10 of such a structure is deformable into a structure having a high space filling rate and a high storage property, making it possible to be carried easily to an external environment or the like. Accordingly, the parallel link apparatus 10 according to the present embodiment makes it possible to perform the imaging with a high reproducibility in a high-speed operation even in an external environment.

### 1.2. Storage Example and Deployment Example

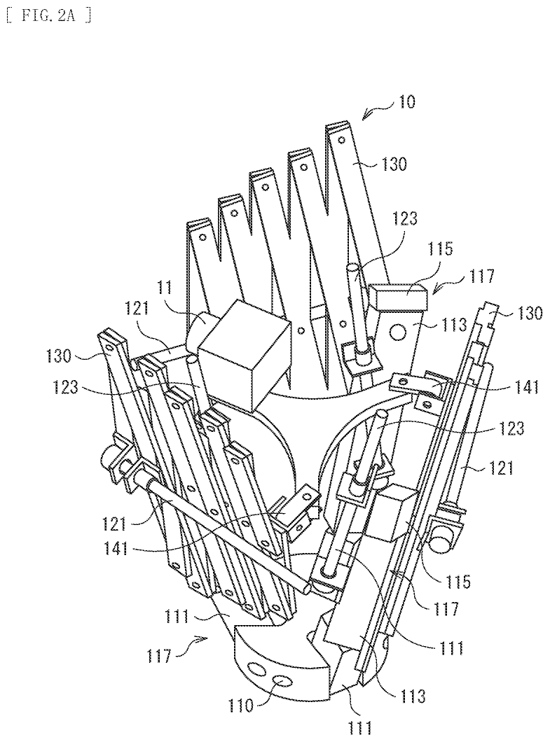

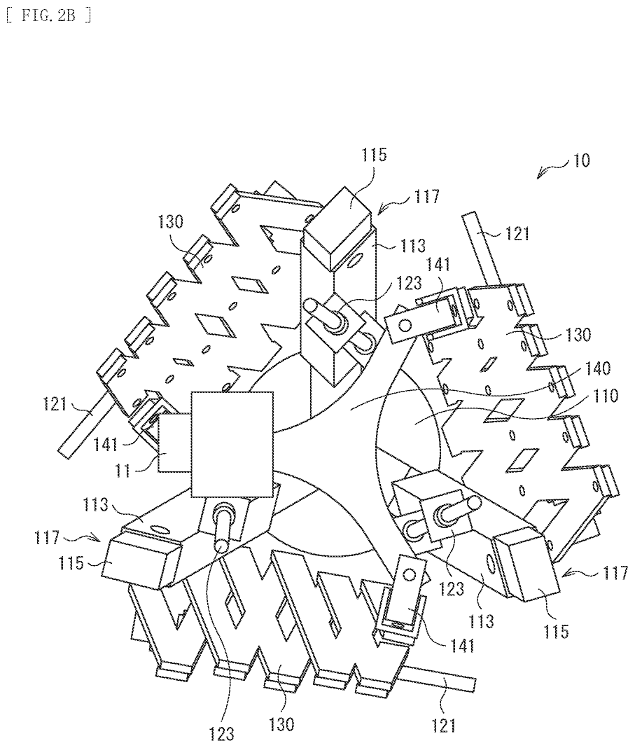

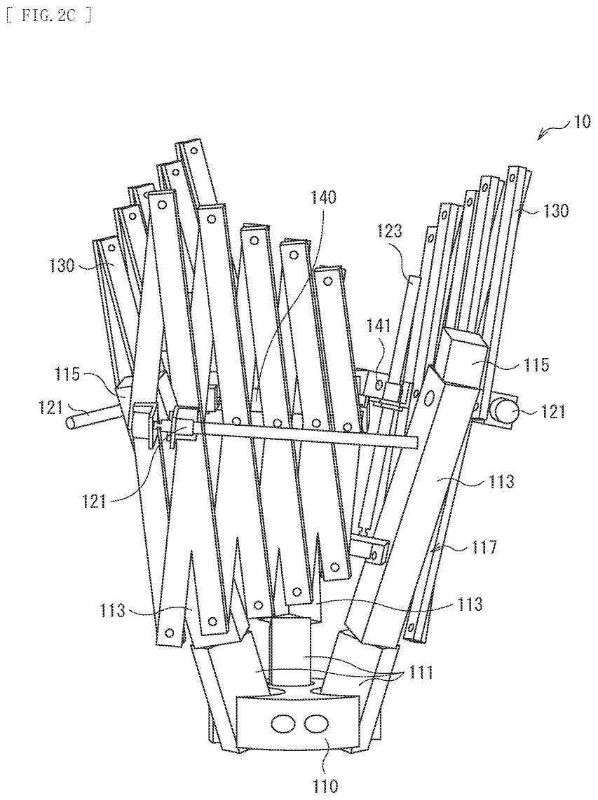

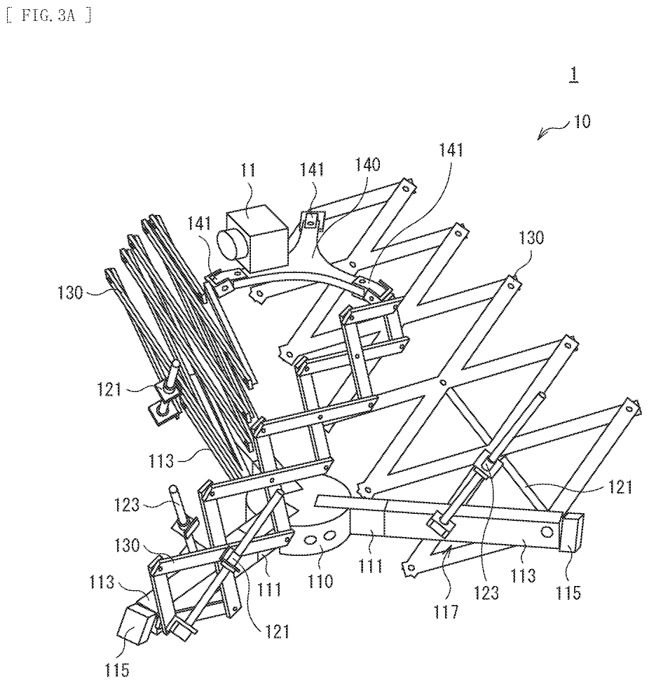

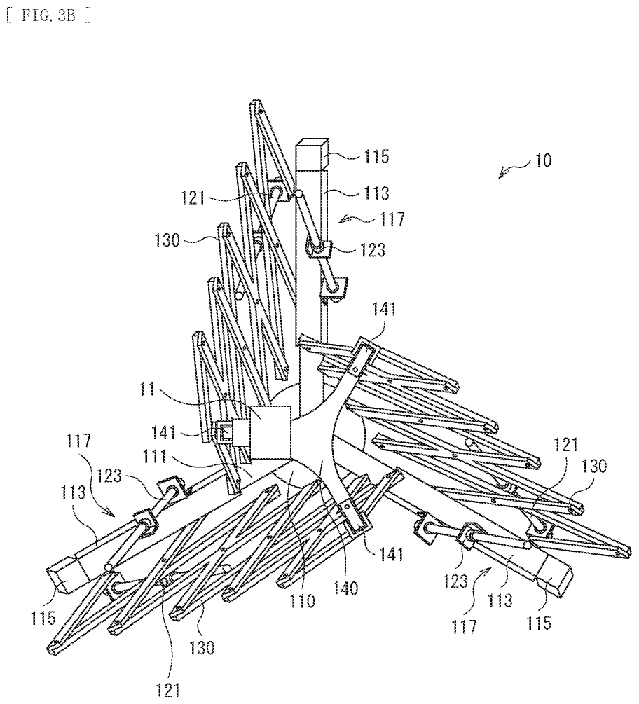

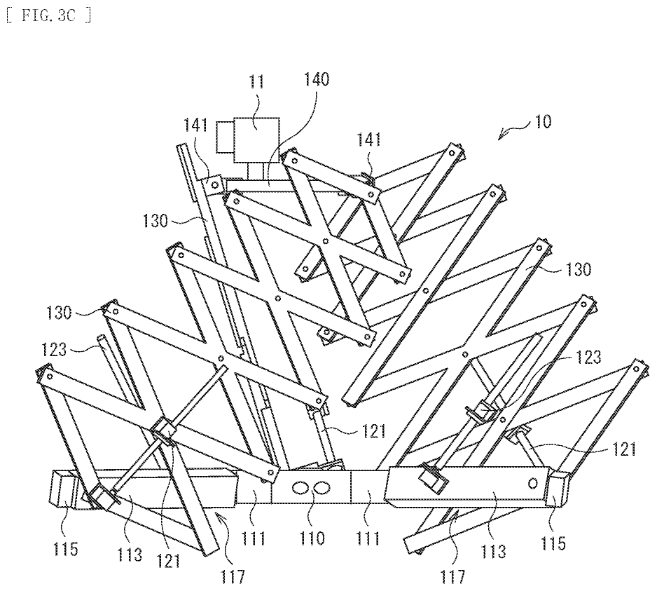

Next, a storage example and a deployment example of the parallel link apparatus 10 according to the present embodiment will be described with reference to FIGS. 2A to 3C. FIG. 2A is a perspective diagram illustrating an example of a storage state of the parallel link apparatus 10 according to the present embodiment, FIG. 2B is a top diagram illustrating an example of the storage state of the parallel link apparatus 10 according to the present embodiment, and FIG. 2C is a side diagram illustrating an example of the storage state of the parallel link apparatus 10 according to the present embodiment. FIG. 3A is a perspective diagram illustrating an example of a deployment state of the parallel link apparatus 10 according to the present embodiment, FIG. 3B is a top diagram illustrating an example of the deployment state of the parallel link apparatus 10 according to the present embodiment, and FIG. 3C is a side diagram illustrating an example of the deployment state of the parallel link apparatus 10 according to the present embodiment.

It is possible for the parallel link apparatus 10 according to the present embodiment to be deformed into the storage state having a high space filling rate and a high storage property in order to facilitate carrying or the like. Specifically, as illustrated in FIGS. 2A to 2C, it is possible for the parallel link apparatus 10 to be deformed into the storage state by causing the deployment sections 117 to pivot in a direction perpendicular to the principal surface of the base section 110 and contracting the pantograph structures of the arm sections 130.

That is, by folding the deployment sections 117 on the side on which the movable section 140 is provided with respect to the principal surface of the base section 110, it is possible for the parallel link apparatus 10 to be deformed into a substantially cylindrical shape in which the base section 110 is a bottom face and the deployment sections 117 are side faces. In addition, it is possible for the parallel link apparatus 10 to be so disposed as to wrap the contracted arm sections 130 in a circumferential direction along the side face of the substantially cylindrical shape formed by the base section 110 and the deployment sections 117. With this configuration, the parallel link apparatus 10 becomes the substantially cylindrical shape in which the base section 110 is the bottom face, the deployment sections 117 and the arm sections 130 as the side faces, and the movable section 140 as an upper face, making it easier to carry.

In the parallel link apparatus 10 in the storage state, the movable section 140 comes close to the deployment section 117 and the second actuator 123. Accordingly, in order to prevent the movable section 140 from coming into contact with the deployment section 117 and the second actuator 123, a planar shape of the movable section 140 may be a shape that is more recessed from a polygonal shape that connects the points at which the tip coupling sections 141 are provided. For example, as illustrated in FIG. 2B, the planar shape of the movable section 140 may be a shape in which respective sides of a triangular shape that connects the points at which the tip coupling sections 141 are provided are bored inwardly from the triangular shape. In addition, in the parallel link apparatus 10 of the storage state, the movable section 140 and the base section 110 may be fixed to each other by a jig or a screw in order to prevent an interference or a contact between the respective members.

In addition, it is possible for the parallel link apparatus 10 according to the present embodiment to be deformed into the deployment state that allows the movable section 140 to be movable in a wide range by spreading the deployment sections 117 in the same plane as the principal surface of the base section 110 at the time of use. Specifically, as illustrated in FIGS. 3A to 3C, it is possible for the parallel link apparatus 10 to be deformed into the deployment state in which the movable section 140 is supported by the plurality of deployment sections 117 and the plurality of arm sections 130 provided in parallel.

The deformation of the parallel link apparatus 10 from the storage state to the deployment state may be performed, for example, by a human hand. At this time, in the parallel link apparatus 10 in the deployment state, a pivot angle between the base section 110 and the deployment section 117 may be fixed by a jig or a screw.

### 1.3. Operation Example

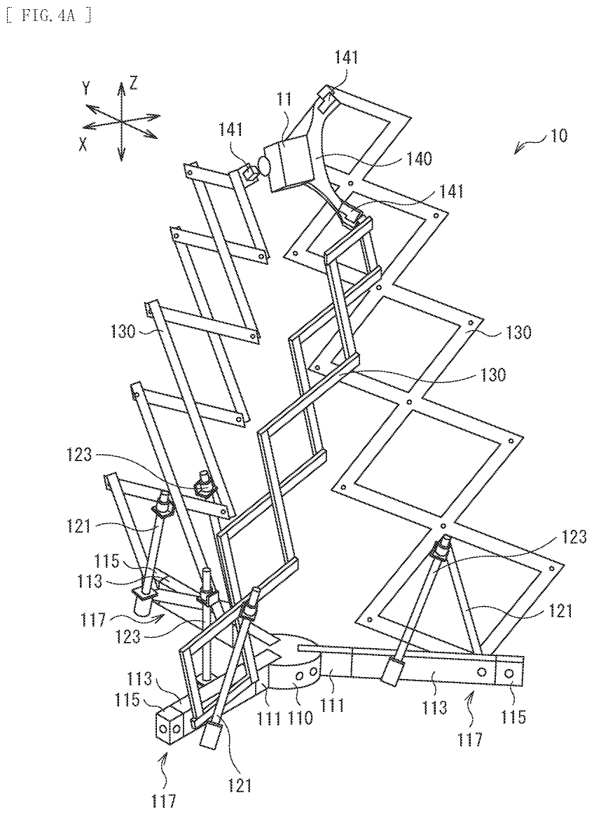

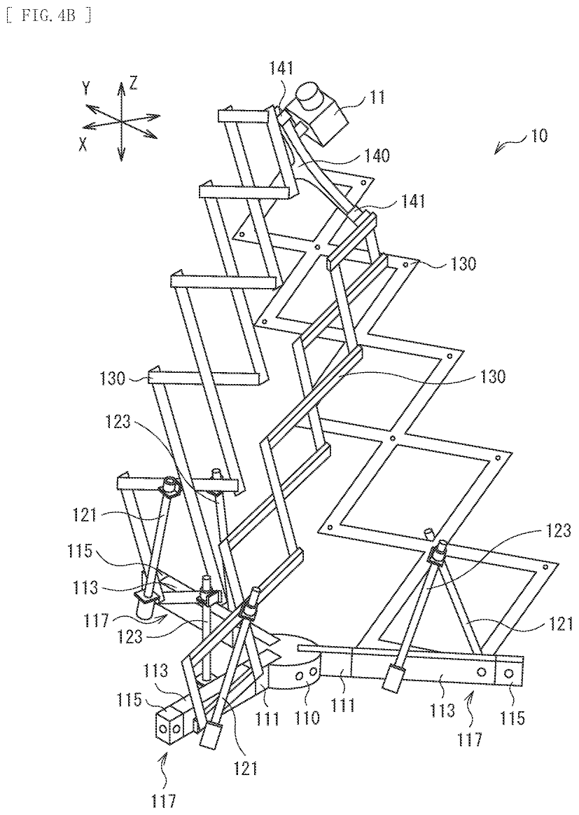

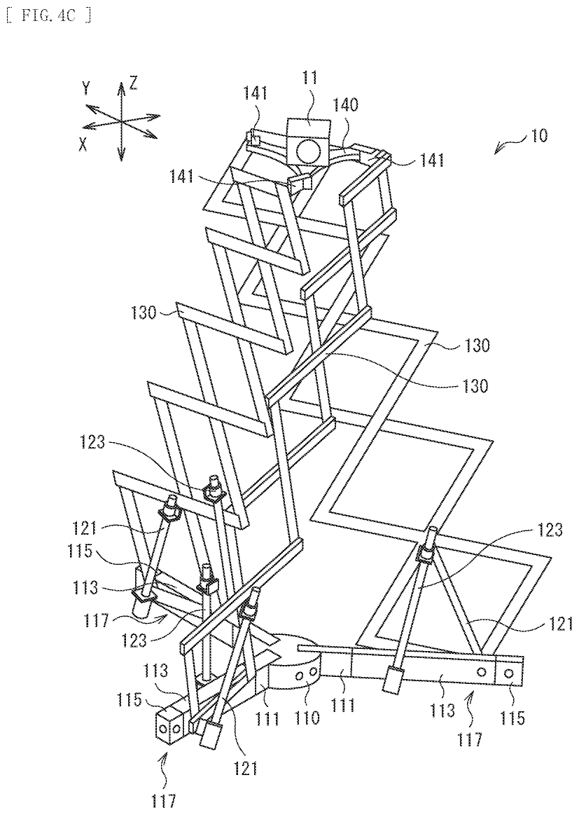

Next, an operation example of the parallel link apparatus 10 according to the present embodiment will be described with reference to FIGS. 4A to 4C. FIGS. 4A to 4C are each a perspective diagram illustrating an example of an attitude change of the movable section 140 in the parallel link apparatus 10 according to the present embodiment.

In the following description, a Z-axis is set in a normal direction of the principal surface of the base section 110, an X-axis is set in a direction orthogonal to the Z-axis in the principal surface of the base section 110, and a Y-axis is set in a direction orthogonal to each of the X-axis and the Z-axis.

As illustrated in FIG. 4A, it is possible for the parallel link apparatus 10 to rotate the movable section 140 about the X-axis by expanding and contracting each of the first actuator 121 and the second actuator 123 provided at each arm section 130. Such a rotation about the X-axis is also referred to as a roll rotation.

As illustrated in FIG. 4B, it is possible for the parallel link apparatus 10 to rotate the movable section 140 about the Y-axis by expanding and contracting each of the first actuator 121 and the second actuator 123 provided at each arm section 130. Such a rotation about the Y-axis is also referred to as a pitch rotation.

As illustrated in FIG. 4C, it is possible for the parallel link apparatus 10 to rotate the movable section 140 about the Z-axis by expanding and contracting each of the first actuator 121 and the second actuator 123 provided at each arm section 130. Such a rotation about the Z-axis is also referred to as a yaw rotation.

It is possible for the parallel link apparatus 10 to allow the movable section 140 to be movable in three translational axes and three rotational axes by driving a total of six of the first actuators 121 and the second actuators 123 provided at each of the three arm sections 130.

### 1.4. Workings and Effects

As described above, according to the present embodiment, provided is the parallel link apparatus 10 in which the space filling rate at the time of storage is high and the transportation is easy.

The parallel link apparatus 10 is provided with the first actuators 121 and the second actuators 123 on the base section 110 side. With this configuration, because it is possible to lower the center of gravity of the parallel link apparatus 10, it is possible to improve a stability upon installation in an environment such as irregular terrain. In addition, because it is possible to lower an inertia of the movable section 140 and reduce a reaction force to be applied to the base section 110 side, it is possible for the parallel link apparatus 10 to improve the stability on the base section 110 side upon movement. Further, because it is possible to reduce the mass of the movable section 140, it is possible for the parallel link apparatus 10 to allow the movable section 140 to be movable at a high speed at a low power consumption.

In addition, because the first actuators 121 and the second actuators 123 are provided on the tip side of the deployment sections 117 and the mass is concentrated outward, it is possible for the parallel link apparatus 10 to further improve the stability upon installation.

Further, because it is possible to allow the movable section 140 to be movable in three translational axes and three rotational axes without using a gimbal structure, it is possible for the parallel link apparatus 10 to improve a stability for a change in the center of gravity such as upon zooming of the imaging device 11.

In addition, it is possible to configure the first actuators 121 and the second actuators 123 of the parallel link apparatus 10 by the motors and the ball screws. With this configuration, it is possible for the parallel link apparatus 10 to suppress the movable section 140 from falling suddenly at the time of a loss of driving power by employing the ball screw with a small lead and lowering the back drivability. In addition, it is possible for the parallel link apparatus 10 to further reduce the power consumption by employing the ball screw with a small lead and reducing a torque necessary at the time of driving. Further, it is possible for the parallel link apparatus 10 to allow the move movable section 140 to be movable with a larger force by using the ball screw having a higher reduction ratio.

### 2. Second Embodiment

### 2.1. Configuration Example

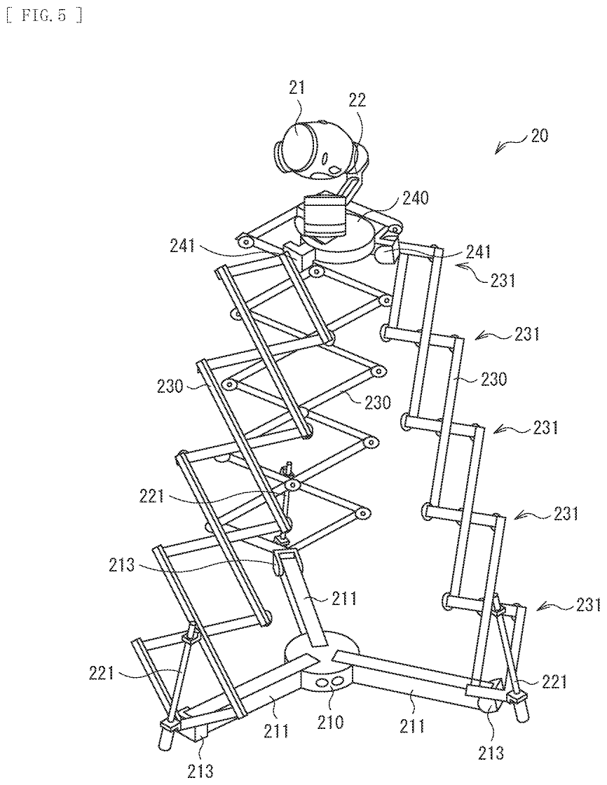

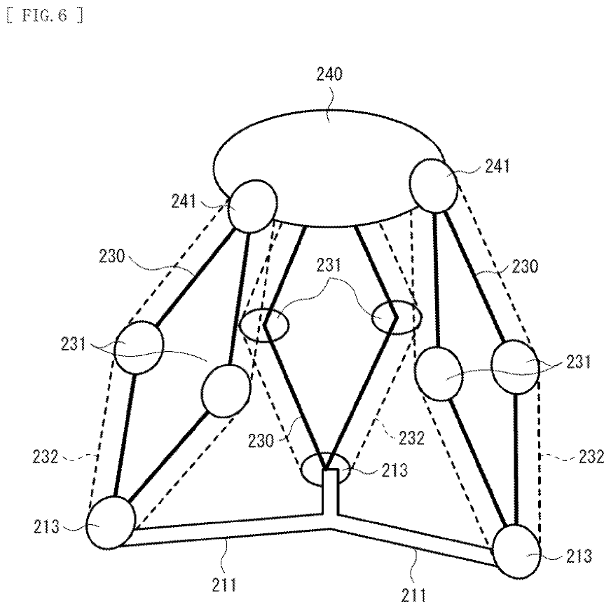

Subsequently, a configuration example of a parallel link apparatus according to a second embodiment of the present disclosure will be described with reference to FIGS. 5 and 6. FIG. 5 is a perspective diagram illustrating a configuration example of a parallel link apparatus 20 according to the present embodiment.

As illustrated in FIG. 5, the parallel link apparatus 20 includes, for example, a base section 210, a deployment section 211, a base end coupling part 213, an arm section 230, an actuator 221, a tip coupling section 241, and a movable section 240.

In the second embodiment as well, each configuration may be formed using various hard-to-deform rigid materials, such as aluminum, stainless steel, or resin, unless otherwise noted. The rigid materials forming the respective configurations may be selected with an emphasis on rigidity, may be selected with an emphasis on lightness, or may be selected with an emphasis on manufacturing costs.

The base section 210 and the movable section 240 are coupled by at least three or more deployment sections 211 and arm sections 230 provided in parallel. The parallel link apparatus 20 is a link device in which a position and an attitude of the movable section 240 are controllable in three translational axes by the actuators 221 that operate the deployment sections 211 and the arm sections 230.

The parallel link apparatus 20 may be used as a pedestal for photographing by installing an imaging device 21 on the movable section 240 via a gimbal structure 22, for example. It is possible for the parallel link apparatus 20 according to the present embodiment to allow the imaging device 21 to be movable freely in three translational axes and three rotational axes via the gimbal structure 22 that achieves three rotational degrees of freedom.

Although FIG. 5 illustrates the parallel link apparatus 20 in which three deployment sections 211, three arm sections 230, and three actuators 221 are provided in parallel, a technique according to the present disclosure is not limited to such an example. For example, the parallel link apparatus 20 may include four or more deployment sections 211, four or more arm sections 230, and four or more actuators 221 in parallel.

It should be noted that, in the present specification, out of the base section 210 and the movable section 240, the base section 210 side is also referred to as a base end side, and the movable section 240 side is also referred to as a tip side.

The base section 210 is a member serving as a base point to be installed on a ground or the like when the parallel link apparatus 20 is used. A shape of the base section 210 is not particularly limited, and may be, for example, a flat plate shape.

The deployment sections 211 extend radially at equal intervals from the base section 210, and are pivotably provided with end parts coupled to the base section 210 serving as pivot axes. Specifically, the deployment sections 211 are provided at even intervals (at 120 degrees each in FIG. 5) so as to be point symmetric with respect to the center of the base section 210. In addition, the deployment section 211 is provided pivotably with respect to a pivot axis in which an axis that passes through a coupling point between the deployment section 211 and the base section 210 and that is orthogonal to the extending direction of the deployment section 211 within a plane of a principal surface of the base section 210 serves as a pivot axis. In other words, the deployment section 211 is pivotably provided so as to be folded in a direction perpendicular to the principal surface of the base section 210 with a coupling part between the deployment section 211 and the base section 210 being the pivot axis.

The deployment section 211 may be provided with, for example, a leg part (not illustrated) that comes into contact with the ground or the like when the parallel link apparatus 20 is installed. The unillustrated leg part may be provided so as to be adjustable in height by a screw or the like, for example, in order to change an installation height of the parallel link apparatus 20. By providing a leg part, it is possible to install the parallel link apparatus 20 more stably. In addition, it is possible for the parallel link apparatus 20 to prevent a portion of the arm section 230 from coming into contact with the installed ground or the like.

The base end coupling part 213 pivotably couples the end part on the tip side of the deployment section 211 and an end part on the base end side of the arm section 230 in two degrees of freedom. In addition, the base end coupling part 213 includes a pulley mechanism, and is so provided as to be able to control a pivot angle on the tip coupling section 241 side via a wire or a belt (not illustrated). The control of the pivot angle by the pulley mechanism will be described later with reference to FIG. 6.

The arm section 230 is pivotably provided in two degrees of freedom with respect to the base section 210 at the end part on the tip side of the deployment section 211. Specifically, the arm section 230 is pivotably coupled to the end part on the tip side of the of deployment section 211 via the base end coupling part 213 in two degrees of freedom. Thus, it is possible for the arm section 230 to pivot, relative to the base section 210, in two degrees of freedom including a pivot axis in which the extending direction of the deployment section 211 serves as an axial direction and a pivot axis in which a direction orthogonal to the extending direction of the deployment section 211 within the plane of the principal surface of the base section 210 serves as an axial direction.

The arm section 230 is provided so as to be extendable and contractible in one direction toward an upper part of the base section 210 by a pantograph structure. The pantograph structure is a structure in which a plurality of contractible rhombic structures is linked, and is extendable and contractible in one direction by the contraction of the rhombic structures. The pantograph structure may be formed, for example, by pivotably coupling end parts of a cross-shaped link in which a middle part is pivotably coupled to end parts of a cross-shaped link having a similar configuration.

The pantograph structure is determined in an expansion contraction rate and an expansion contraction length by the number of couplings of the rhombic structures and a length of each of the links forming the rhombic structures. The expansion contraction rate and the expansion contraction length of the pantograph structure of the arm section 230 may be appropriately designed depending on an application of the parallel link apparatus 20. However, the pantograph structure of the arm section 230 may be configured such that the rhombic structure on the tip side is smaller than the rhombic structure on the base end side in order to prevent an interference or a contact of the mutual arm sections 230 in the vicinity of the movable section 240.

In addition, the pantograph structure of the arm section 230 is provided with pulley mechanisms 231. Specifically, the pulley mechanism 231 as a disk-shaped rotary wheel is provided at a top on an outer side of the rhombic structure of the pantograph structure of the arm section 230. For each pulley mechanism 231, a wire, a belt, or the like (not illustrated) is stretched with a tension being applied in such a manner as to connect the pulley mechanism of the base end coupling part 213 and a pulley mechanism of the tip coupling section 241 and as to surround the surroundings of the pantograph structure.

The actuator 221 generates a power that causes the arm section 230 to expand and contract in one direction. Specifically, the actuator 221 may include a ball screw provided on the diagonal of the rhombic structure on the most base end side of the pantograph structure of the arm section 230, and a motor that rotates the ball screw. Because it is possible for the actuator 221 to contract each of the rhombic structures constituting the pantograph structure of the arm section 230 in conjunction with each other by the ball screw, it is possible to expand and contract the arm section 230 in one direction.

The ball screw is configured by a threaded shaft, a nut, a ball, or the like, and is a mechanical element that converts a rotational motion of the motor into a linear motion. Because the ball screw has a low back drivability, it is possible to suppress the arm section 230 from rapidly contracting or falling down even in a case where the power from the motor is lost. In addition, it is possible for the ball screw to lower the back drivability by making a lead of the threaded shaft smaller.

The tip coupling sections 241 are provided at the movable section 240 at equal intervals so as to be point symmetric with respect to the center of the movable section 240. The tip coupling sections 241 pivotably couple the end parts on the tip end side of the respective arm sections 230 and the movable section 240 in two degrees of freedom. In addition, the tip coupling section 241 includes a pulley mechanism, and a pivot angle is controlled on the basis of the pivot angle of the base end coupling part 213 via a wire or a belt (not illustrated).

The movable section 240 is a member that is made movable in the parallel link apparatus 20 by the expansion and the contraction and the pivot of each of the arm sections 230. Specifically, the movable section 240 is coupled to each of the arm sections 230 at the tip coupling sections 241 and is made movable in three translational axes by the expansion and the contraction and the pivot of each of the arm sections 230.

The imaging device 21 is mounted on the movable section 240 via the gimbal structure 22, for example. Because the gimbal structure 22 is movable in three rotational axes, it is possible for the imaging device 21 to be movable freely in three translational axes and three rotational axes. The gimbal structure 22 may be provided at a middle part of the movable section 240 or may protrude from an edge part of the movable section 240.

In the second embodiment, the pivot angle between the movable section 240 and the arm sections 230 is controlled so that the principal surface of the movable section 240 and the principal surface of the base section 210 become parallel in order to allow the movable section 240 to be movable in three translational axes. A mechanism that controls the pivot angle will be described with reference to FIG. 6. FIG. 6 is a schematic diagram illustrating a configuration of the parallel link apparatus 20 in a simplified fashion. In FIG. 6, the pantograph structures of the arm sections 230 are each omitted and illustrated to have one rhombic structure.

As described above, the top on the outer side of the rhombic structure constituting the pantograph structure of the arm section 230 is provided with the pulley mechanism 231. The base end coupling part 213 and the tip coupling section 241 are so provided as to include the pulley mechanisms. The pulley mechanism is a disk-shaped rotary wheel, and allows power and a rotation to be transmitted between the pulley mechanisms by spanning a flexible cord-like object such as a wire or a belt around an outer circumference of the rotary wheel.

Here, as illustrated in FIG. 6, a cord-like object 232 such as a wire or a belt is so spanned around an outer circumference of each of the pulley mechanisms as to connect each of the pulley mechanisms 231 provided at the tops on the outer side of the rhombic structure of the pantograph structure, the pulley mechanism included in the tip coupling section 241, and the pulley mechanism included in the base end coupling part 213.

Thus, each of the pulley mechanisms 231 and the pulley mechanism included in the tip coupling section 241 are caused to rotate with the rotation of the pulley mechanism included in the base end coupling part 213 by a friction with the cord-like object 232. Hence, in a case where the arm section 230 pivots with respect to the deployment section 211, the pulley mechanism of the tip coupling section 241 also rotates with the rotation of the pulley mechanism of the base end coupling part 213, so that the movable section 240 pivots with respect to the arm section 230. With this configuration, it is possible for the parallel link apparatus 20 to maintain an attitude of the movable section 240 to the base section 210 and the deployment sections 211.

### 2.2. Storage Example and Deployment Example

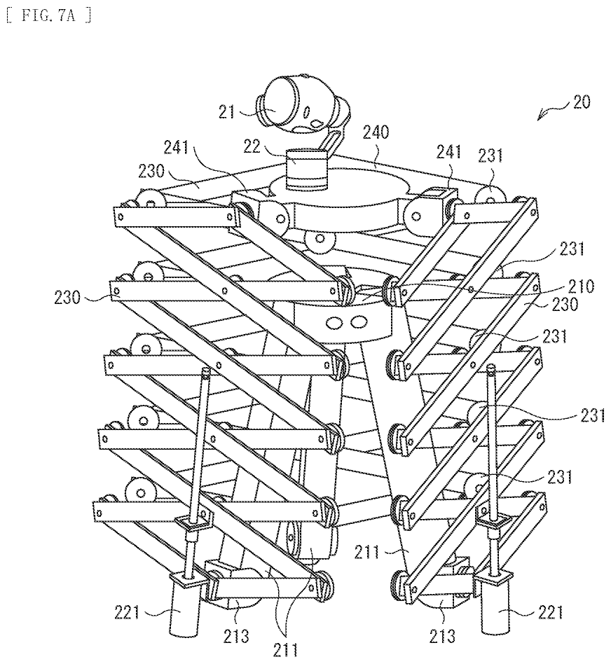

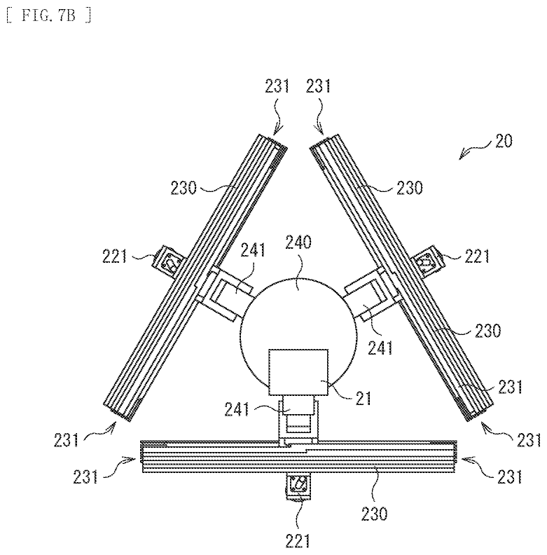

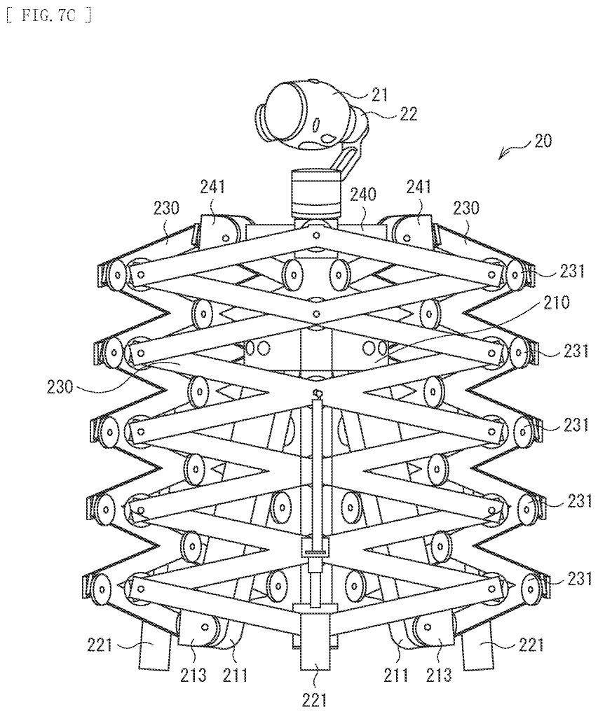

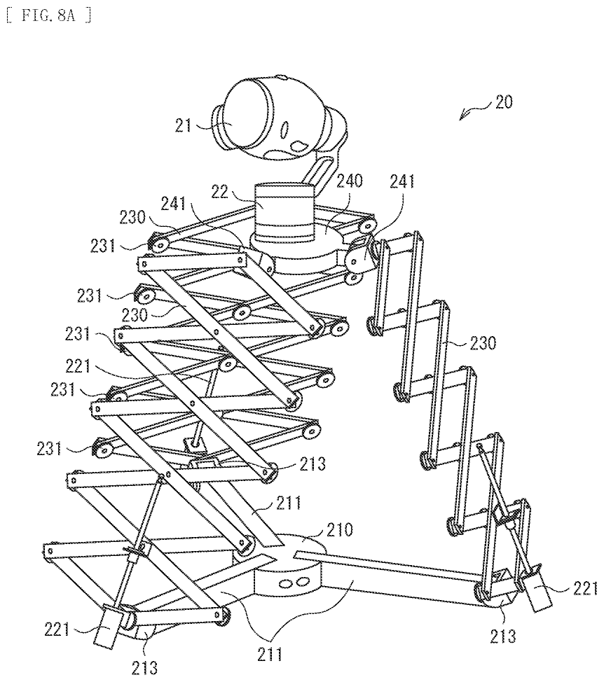

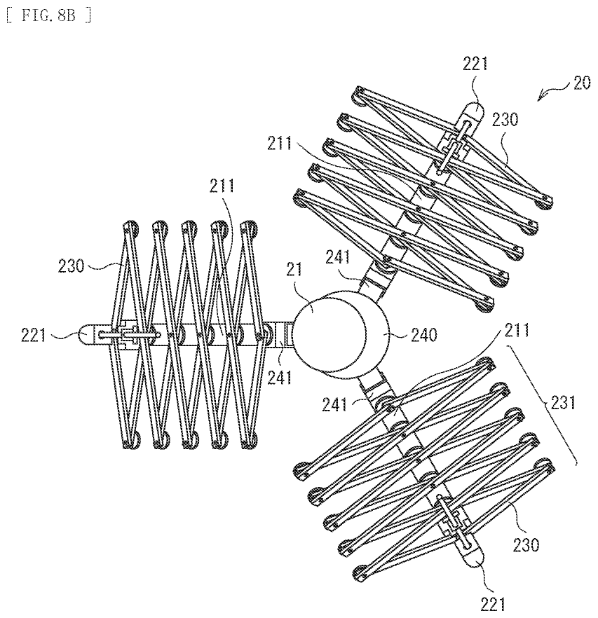

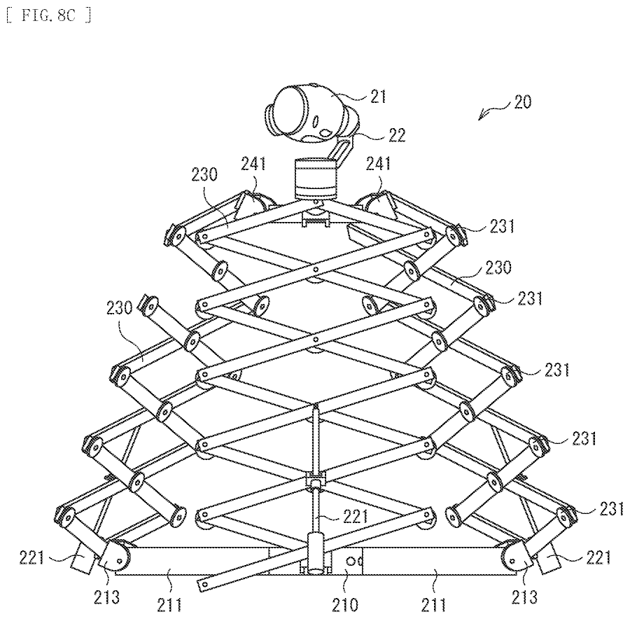

Next, a storage example and a deployment example of the parallel link apparatus 20 according to the present embodiment will be described with reference to FIGS. 7A to 8C. FIG. 7A is a perspective diagram illustrating an example of a storage state of the parallel link apparatus 20 according to the present embodiment, FIG. 7B is a top diagram illustrating an example of the storage state of the parallel link apparatus 20 according to the present embodiment, and FIG. 7C is a side diagram illustrating an example of the storage state of the parallel link apparatus 20 according to the present embodiment. FIG. 8A is a perspective diagram illustrating an example of a deployment state of the parallel link apparatus 20 according to the present embodiment, FIG. 8B is a top diagram illustrating an example of the deployment state of the parallel link apparatus 20 according to the present embodiment, and FIG. 8C is a side diagram illustrating an example of the deployment state of the parallel link apparatus 20 according to the present embodiment.

As with the parallel link apparatus 10 according to the first embodiment, it is possible for the parallel link apparatus 20 according to the present embodiment to be deformed into the storage state having a high space filling rate and a high storage property in order to facilitate carrying or the like. Specifically, as illustrated in FIGS. 7A to 7C, it is possible for the parallel link apparatus 20 to be deformed into the storage state by causing the deployment sections 211 to pivot in a direction perpendicular to the principal surface of the base section 210 and contracting the pantograph structures of the arm sections 230.

That is, by folding the deployment sections 211 to a side opposite to a side on which the movable section 240 is provided with respect to the principal surface of the base section 210, it is possible to store the base section 210 and the deployment sections 211 inside a substantially triangular prism shape in which the movable section 240 is a top face and the contracted arms sections 230 are side faces. With this configuration, the parallel link apparatus 20 becomes the substantially triangular prism shape in which the movable section 240 is the top face and the arms sections 230 are the side faces, making it easier to carry.

In the parallel link apparatus 20 in the storage state, the movable section 240 comes close to the base section 210. Accordingly, in the parallel link apparatus 20 in the storage state, the movable section 240 and the base section 210 may be fixed to each other by a jig or a screw in order to prevent an interference or a contact between the respective members.

In addition, it is possible for the parallel link apparatus 20 according to the present embodiment to be deformed into the deployment state that allows the movable section 240 to be movable in a wide range by spreading the deployment sections 211 in the same plane as the principal surface of the base section 210 at the time of use. Specifically, as illustrated in FIGS. 8A to 8C, it is possible for the parallel link apparatus 20 to be deformed into the deployment state in which the movable section 240 is supported by the plurality of deployment sections 211 and the plurality of arm sections 230 provided in parallel.

The deformation of the parallel link apparatus 20 from the storage state to the deployment state may be performed, for example, by a human hand. At this time, in the parallel link apparatus 20 in the deployment state, the pivot angle between the base section 210 and the deployment section 211 may be fixed by a jig or a screw.

### 2.3. Operation Example

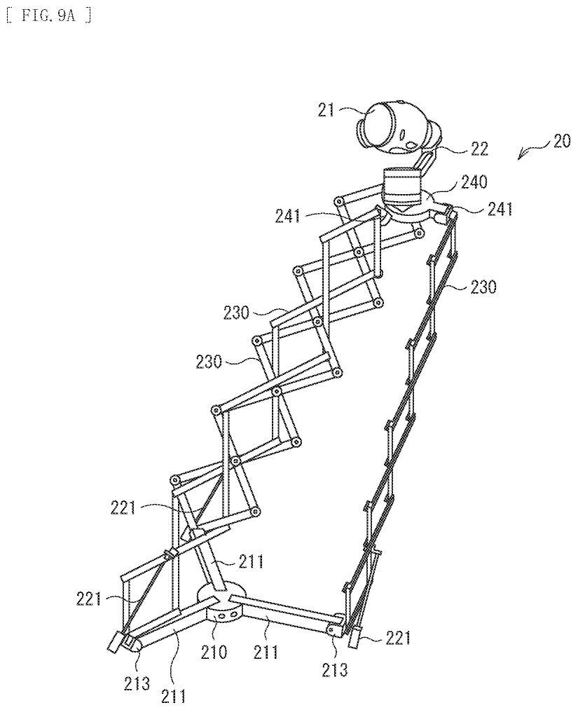

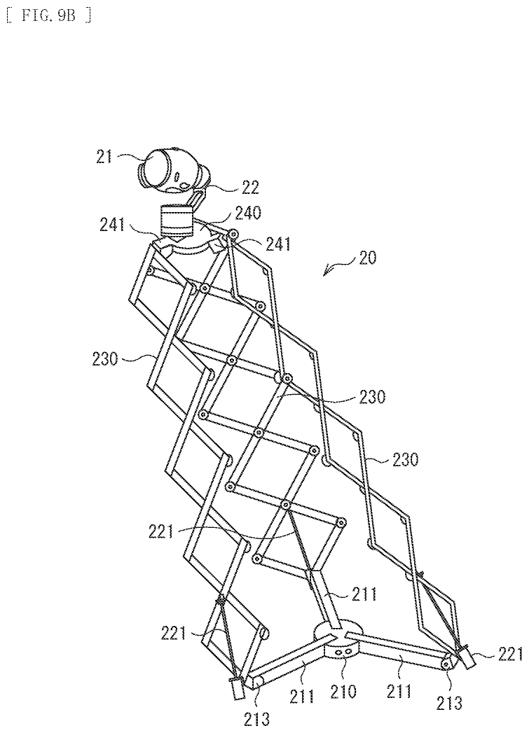

Next, an operation example of the parallel link apparatus 20 according to the present embodiment will be described with reference to FIGS. 9A to 9C. FIGS. 9A to 9C are each a perspective diagram illustrating an example of an attitude change of the movable section 240 in the parallel link apparatus 20 according to the present embodiment.

As illustrated in FIGS. 9A and 9B, it is possible for the parallel link apparatus 20 to translate the movable section 240 over a wide range by expanding and contracting each of the actuators 221 provided at the respective arm sections 230. At this time, the pivot angle between the movable section 240 and the arm sections 230 is controlled by the pulley mechanism included in the tip coupling section 241, the pulley mechanisms 231 provided at the pantograph structures of the arm sections 230, and the pulley mechanism included in the base end coupling part 213. Thus, it is possible for the movable section 240 to move in translation while maintaining a parallel state with respect to the base section 210.

It is possible for the parallel link apparatus 20 to allow the movable section 240 to be movable in three translational axes by driving a total of three of the actuators 221 provided at the respective three arm sections 230.

### 2.4. Modification Example

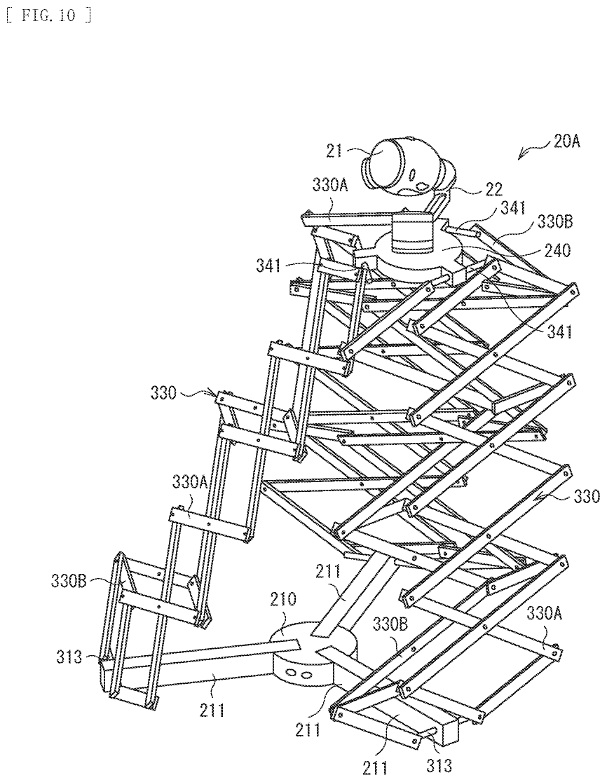

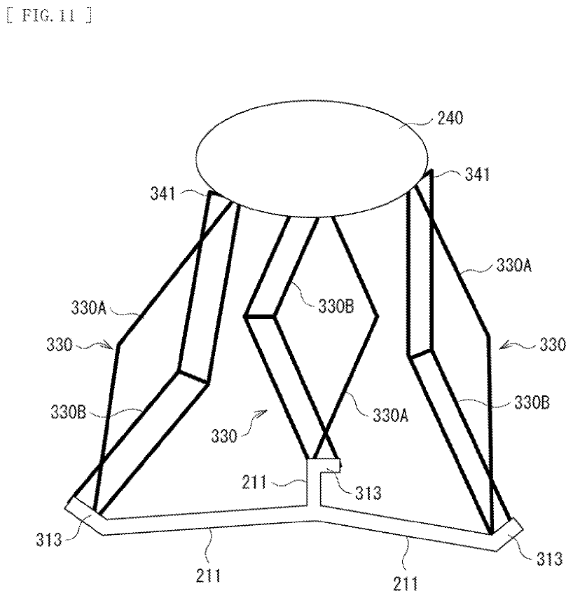

Next, a modification example of the parallel link apparatus 20 according to the present embodiment will be described with reference to FIGS. 10 and 11. FIG. 10 is a perspective diagram illustrating a configuration example of a parallel link apparatus 20A according to the present modification example. FIG. 11 is a schematic diagram illustrating a configuration of the parallel link apparatus 20A in a simplified fashion. In FIG. 11, the pantograph structures of the arm sections 230 are each omitted and illustrated to have one rhombic structure.

As illustrated in FIG. 10, the parallel link apparatus 20A includes, for example, the base section 210, the deployment section 211, a base end coupling part 313, an arm section 330, a tip coupling section 341, and the movable section 240. It should be noted that, in FIG. 10, illustration of the actuator 221 that generates the power for expanding and contracting the arm section 330 in one direction is omitted.

The parallel link apparatus 20A according to the present modification example differs from the parallel link apparatus 20 illustrated in FIG. 5 in a mechanism that controls the pivot angle between the movable section 240 and the arm sections 230 and causes the principal surface of the movable section 240 and the principal surface of the base section 210 to be parallel. That is, the parallel link apparatus 20A according to the present modification example differs from the parallel link apparatus 20 illustrated in FIG. 5 in configurations of the base end coupling part 313, the arm section 330, and the tip coupling section 341.

The base end coupling part 313 pivotably couples the end part on the tip side of the deployment section 211 and the end part on the base end side of the arm section 330. Specifically, the base end coupling part 313 is provided as a shaft part whose both ends are held by two links included in the arm sections 330 and that penetrates the deployment section 211. Thus, it is possible for the arm section 330 to pivot relative to the deployment section 211 with the base end coupling part 313 serving as a pivot axis.

The tip coupling sections 341 are provided at the movable section 240 at equal intervals so as to be point symmetric with respect to the center of the movable section 240. The tip coupling sections 341 pivotably couple the end parts on the tip side of the respective arm sections 330 and the movable section 240. Specifically, the tip coupling sections 341 is provided as a shaft part whose both ends are held by two links included in the arm sections 330 and that penetrates the movable section 240. Thus, it is possible for the arm section 330 to pivot relative to the movable section 240 with the tip coupling sections 341 serving as a pivot axis.

The arm section 330 is pivotably provided at the end part on the tip side of the deployment section 211 via the base end coupling part 313. Specifically, as illustrated in FIG. 11, the arm section 330 includes a pantograph structure 330A and a parallelogram link structure 330B, and is so provided as to sandwich both ends of the base end coupling part 313 and the tip coupling section 341 by a link included in the pantograph structure 330A and a link included in the parallelogram link structure 330B.

As with the arm section 230 of the parallel link apparatus 20 illustrated in FIG. 5, the pantograph structure 330A is a structure in which a plurality of contractible rhombic structures is linked, and is extendable and contractible in one direction by the contraction of the rhombic structures.

The parallelogram link structure 330B is a structure that forms a parallelogram link with a link of a portion of the pantograph structure 330A. Specifically, the parallelogram link structure 330B forms the parallelogram link in a normal direction of a plane in which the rhombic structure of the pantograph structure 330A is formed. The parallelogram link structure 330B may form the parallelogram link for each link, of the pantograph structure 330A, that connects a link that holds the base end coupling part 313 to a link that holds the tip coupling section 341. By forming the parallelogram link structure 330B, it is possible for the base end coupling part 313 provided at the both ends of the arm section 330 and the tip coupling section 341 to maintain a parallel state with respect to each other regardless of the expansion and the contraction of the arm section 330.

It is possible for the parallel link apparatus 20A according to the present modification example to maintain the parallel state between the base end coupling part 313 and the tip coupling section 341 by forming the arm section 330 by the structure that includes the pantograph structure 330A and the parallelogram link structure 330B. Thus, it is possible for the parallel link apparatus 20A according to the present modification example to cause the movable section 240 to move in translation while maintaining the parallel state between the base section 210 and the movable section 240.

### 2.5. Workings and Effects

As described above, according to the present embodiment, the parallel link apparatus 20 having the high space filling rate at the time of storage and that is easy to transport is provided as with the first embodiment.

It is possible for the parallel link apparatus 20 to allow the imaging device 21 to be movable in three rotational axes by using the gimbal structure 22 provided on the movable section 240. Because it is possible for the gimbal structure 22 to set a rotation movable range regardless of a structure of the parallel link apparatus 20, it is possible for the parallel link apparatus 20 to further expand the rotation movable range as compared with the parallel link apparatus 10 according to the first embodiment.

It should be noted that, with respect to a change in the center of gravity at the time of zooming or the like of the imaging device 21, it is possible for the parallel link apparatus 20 to further improve an attitude holding property of the gimbal structure 22 by using a geared motor or the like which is difficult to back-drive.

### 3. Appendix

A technique according to the present disclosure has been described above with reference to the first and the second embodiments and the modification examples. However, the technique according to the present disclosure is not limited to the above-described embodiments and the like, and various modifications can be made. Hereinafter, another modification example of the technique according to the present disclosure will be described by exemplifying the parallel link apparatus 10 according to the first embodiment, but it is needless to say that this applies similarly to the parallel link apparatus 20 according to the second embodiment.

For example, the parallel link apparatus 10 may be provided with a potentiometer or the like at a coupling part between the base section 110 and the deployment section 117. With this configuration, it is possible for the parallel link apparatus 10 to be installed, as the deployment state, in a bent state in which the base section 110 and the deployment section 117 do not present in the same plane.

In addition, for example, the parallel link apparatus 10 may be provided with a linear sensor at the first actuator 121 and the second actuator 123 that acquires linear position information of the ball screw, in order to sense an attitude of the movable section 140 upon operation. As the linear sensor, for example, it is possible to use a wire winding type linear sensor.

In such a case, the parallel link apparatus 10 may perform a calibration of the linear sensor using a captured image from the imaging device 11 upon operation or information acquired by a 9-axis motion sensor (IMU) provided at the movable section 140. Further, the parallel link apparatus 10 may perform the calibration of an initial state of the linear sensor by starting the operation from a predetermined initial position in the deployment state. The predetermined initial position in the deployment state of the parallel link apparatus 10 may be, for example, a position in which the base section 110 and the deployment section 117 are fixed by a jig or the like and the arm sections 130 are most contracted.

Further, not all of the configurations and operations described in the respective embodiments are essential to the configuration and the operation of the present disclosure. For example, among the elements in the respective embodiments, elements not described in an independent claim based on the most generic concept of the present disclosure are to be understood as optional components.

The terms used throughout this specification and the appended claims should be construed as “non-limiting” terms. For example, the terms “including” or “included” should be construed as “not being limited to an embodiment in which it is described as including”. The term “has” should be construed as “not being limited to an embodiment in which it is described as having”.

The terms used in this specification are used merely for convenience of description and include terms that are not used for the purpose of limiting a configuration and an operation. For example, terms such as “right,” “left,” “up,” or “down” merely indicate a direction in the drawing being referenced. In addition, the terms “inner” and “outer” merely indicate directions toward the center of an element of interest and away from the center of the element of interest, respectively. This applies similarly to terms similar to these terms and terms having the similar meanings.

It should be noted that the technique according to the present disclosure may have the following configurations. According to the technique of the present disclosure having the following configurations, it is possible to provide a parallel link apparatus that supports the movable section by three or more deployment sections that extend radially from the base section and that are pivotable with the end parts coupled to the base section being the pivot axes and by the arm sections that are coupled to the respective end parts of the deployment sections and are pivotable with respect to the deployment sections and expandable and contractible in one direction independently of each other. Because it is possible for such a parallel link apparatus to be deformed in into a shape in which the deployment sections are folded in a direction perpendicular to the principal surface of the base section, it is possible for the parallel link apparatus to be deformed into the storage state having the higher space filling rate. Accordingly, because the storage property is increased, it is possible for the parallel link apparatus to improve easiness of transportation. An effect to be exerted by the technique according to the present disclosure is not necessarily limited to the effect described herein, and may be any of the effects described in the present disclosure.

(1)

A parallel link apparatus including:

a base section;

three or more deployment sections that extend radially from the base section and that are pivotable with end parts coupled to the base section being pivot axes;

arm sections that are coupled to end parts, of the respective deployment sections, that are on opposite sides of the end parts coupled to the base section, and are pivotable with respect to the deployment sections and expandable and contractible in one direction independently of each other; and

a movable section coupled to each of second ends, of the arm sections, that are on opposite sides of first ends, of the arm sections, coupled to the deployment sections.

(2)

The parallel link apparatus according to (1), in which the arm sections have a pantograph structure.

(3)

The parallel link apparatus according to (2), in which the pantograph structure is provided such that a rhombic structure on the second end side is smaller than a rhombic structure on the first end side.

(4)

The parallel link apparatus according to any one of (1) to (3), in which the first end side of the arm sections is provided with first actuators that expand and contract the arm sections.

(5)

The parallel link apparatus according to (4), in which the first end side of the arm sections is provided with second actuators that cause the arm sections to pivot relative to the deployment sections.

(6)

The parallel link apparatus according to (5), in which the first actuators and the second actuators include ball screws.

(7)

The parallel link apparatus according to any one of (1) to (6), further including fixing mechanisms that fix pivot positions of the deployment sections relative to the base section.

(8)

The parallel link apparatus according to any one of (1) to (7), in which the deployment sections are provided in a point symmetrical arrangement with respect to center of the base section.

(9)

The parallel link apparatus according to any one of (1) to (8), in which the arm sections are coupled to the movable section in a point symmetric arrangement with respect to center of the movable section.

(10)

The parallel link apparatus according to any one of (1) to (9), in which the respective arm sections expand and contract in directions that are torsional with respect to each other.

(11)

The parallel link apparatus according to any one of (1) to (9), in which a coupling angle between the arm sections and the movable section is controlled on the basis of coupling angles between the arm sections and the deployment sections.

(12)

The parallel link apparatus according to (11), in which the movable section is translationally movable with respect to the base section.

(13)

The parallel link apparatus according to any one of (1) to (12), further including an imaging device provided on the movable section.

(14)

The parallel link apparatus according to (13), in which the imaging device is provided on the movable section via a gimbal structure.

The present application claims the benefit of Japanese Priority Patent Application JP2019-225421 filed with the Japan Patent Office on Dec. 13, 2019, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A parallel link apparatus comprising:
a base section;
three or more deployment sections that extend radially from the base section and that are pivotable with end parts coupled to the base section being pivot axes;
arm sections that are coupled to end parts, of the respective deployment sections, that are on opposite sides of the end parts coupled to the base section, and are pivotable with respect to the deployment sections and expandable and contractible in one direction independently of each other; and
a movable section coupled to each of second ends, of the arm sections, that are on opposite sides of first ends, of the arm sections, coupled to the deployment sections.

2. The parallel link apparatus according to claim 1, wherein the arm sections have a pantograph structure.

3. The parallel link apparatus according to claim 2, wherein the pantograph structure is provided such that a rhombic structure on the second end side is smaller than a rhombic structure on the first end side.

4. The parallel link apparatus according to claim 1, wherein the first end side of the arm sections is provided with first actuators that expand and contract the arm sections.

5. The parallel link apparatus according to claim 4, wherein the first end side of the arm sections is provided with second actuators that cause the arm sections to pivot relative to the deployment sections.

6. The parallel link apparatus according to claim 5, wherein the first actuators and the second actuators comprise ball screws.

7. The parallel link apparatus according to claim 1, further comprising fixing mechanisms that fix pivot positions of the deployment sections relative to the base section.

8. The parallel link apparatus according to claim 1, wherein the deployment sections are provided in a point symmetrical arrangement with respect to center of the base section.

9. The parallel link apparatus according to claim 1, wherein the arm sections are coupled to the movable section in a point symmetric arrangement with respect to center of the movable section.

10. The parallel link apparatus according to claim 1, wherein the respective arm sections expand and contract in directions that are torsional with respect to each other.

11. The parallel link apparatus according to claim 1, wherein a coupling angle between the arm sections and the movable section is controlled on a basis of coupling angles between the arm sections and the deployment sections.

12. The parallel link apparatus according to claim 11, wherein the movable section is translationally movable with respect to the base section.

13. The parallel link apparatus according to claim 1, further comprising an imaging device provided on the movable section.

14. The parallel link apparatus according to claim 13, wherein the imaging device is provided on the movable section via a gimbal structure.
